(19) United States
(12) Patent Application Publication
(10) Pub. No.: US 2025/0252519 A1
(43) Pub. Date: Aug. 7, 2025

(54) STIMULATING STUDENT LEARNING SKILLS THROUGH A VOICE-ACTIVATED INSTRUCTIONAL AID

(71) Applicant: Karen Jean Warner, Stillwater, OK (US)

(72) Inventor: Karen Jean Warner, Stillwater, OK (US)

(21) Appl. No.: 19/043,573

(22) Filed: Feb. 3, 2025

Related U.S. Application Data
(60) Provisional application No. 63/548,689, filed on Feb. 1, 2024.

(51) Int. Cl. G06Q 50/20

(52) U.S. Cl. CPC G06Q 50/205

(57) ABSTRACT

The Stimulating Student Learning Skills Through a Voice-Activated Instructional Aid is a system that includes a voice-activated system that can effectively infuse student learning strategy instruction with current teaching strategies effectively, efficiently and consistently using over ten years of research that are proven to raise student achievement. These learning strategies were used to develop into over 100 student tools that could be integrated within common teaching strategies to increase student comprehension and retention of content. Through step-by-step student directives, conducive to voice technology, allows for immediate integration within the classroom.

### CROSS-REFERENCE TO RELATED APPLICATIONS

Not applicable

### STATEMENT REGARDING FEDERALLY SPONSORED RESEARCH OR DEVELOPMENT

Not applicable

### FIELD OF THE EMBODIMENTS

The field of the embodiments is instructional support for teachers to stimulate student learning skills.

### BACKGROUND OF THE EMBODIMENTS

The lack of student achievement continues to be one of our biggest challenges in classrooms across our nation. According to the Center of Public Education and the National Boards Association, the struggle for teachers is not learning new approaches to teaching but implementing them. As a result, unfortunately, further findings show that “most teachers do not teach the strategies students need to comprehend and learn.” Gaskins, Irene, Strategies Instruction. Education.com, Dec. 23, 2009 update, available at http://www.education.com/-reference/article/strategies-instruction/, last visited Jan. 18, 2015). The use of voice technology as instructional support, to intervene and align scientifically researched student learning and processing strategies with teacher strategies will help improve and overcome these challenges in today's classroom in a unique and innovative manner. The need for such development is further reiterated by Dr. Irene Gaskins, educational leader, when she explains the need for student learning strategy instructional support in our classrooms across our nation. “In order for the United States to produce young people who are well prepared to succeed in whatever they undertake, every teacher at every grade level in every domain must become a strategies teacher. Strategic instruction needs to be adopted across the curriculum and throughout schools and school districts. It needs to begin when children enter school and continue through 12th grade.” Gaskins, Dec. 23, 2009.

Research clearly shows us that without instructional intervention, using comprehension and retention techniques, only minimal learning results are being achieved, and surface learning is being generated for many students in classrooms across the nation. Unfortunately, due to many classroom challenges and time constraints, teachers are left doing an abundant number of lectures within the classroom. However, unfortunately, as much as 50% of the knowledge may be lost within 20 minutes.” J. LaBonty & K. E. Danielson, Writing poems to gain deeper meaning in science, 36 Middle School Journal 30 (2005). Whereas “information, deemed important is often taught just one time and is expected to be remembered a lifetime” David A. Sousa, Memory, Retention and Learning. How the Brain Learns 119-120 (2011). For another instance, in today's classroom, for reflection and review, study sheets are being used abundantly in classrooms across our nation” knowing or not knowing that “answering study questions require only low-level recognition” Goodwin, Bryan, Research Says/Teach Critical Thinking to Teach Writing 71 Educational Leadership 78 (2014). Therefore, “learning is stopping short of the reorganization of thinking that deep learning requires” P. T. Ewell, Organizing for Learning: A Point of Entry. AAHE Summer Academy at Snowbird. National Center for Higher Education Management Systems (NCHEMS) (1997); Intime, Integrating New Technologies into the Methods of Education, Reflection. Principles of Learning, 1999-2001. In conclusion, using voice-activated instructional supports that intervene and provide multiple student learning retention tools, related to all facets of a lesson, can help guide students to create deep, long-lasting learning connections.

Unfortunately, findings also show that “most teachers do not teach the strategies students need to comprehend and learn.” Pressley Durkin, Mistretta Wharton-McDonald, & Irene Gaskins Echevarria, Strategies Instruction, Education.com (1990) (available at http://www.education.com/reference/article/strategies-instruction/, last visited Jan. 1, 2024), To make matters worse, “poor learners, who lack comprehension and retention skills, are less likely to invent their own effective strategies or learning skills without being taught, Stephen D. Luke, 1 Evidence for Education (10/2010 Update). Center for Parent Information and Resources, The Power of Strategy Education, (available at http://www.parentcenterhub.org/repository/learning-strategies/(last visited Feb. 5, 2015). Then, regrettably, students who do not know or use good learning strategies often learn passively and ultimately fail in school. University of Kansas Center for Research on Learning, Learning Strategies (2015). To overcome this fallacy, Dr. Gaskins claims that “the success of strategies instruction depends on instructional supports being incorporated into the instruction, if the use of strategies is to become habitual for students” Irene Gaskins, Strategies Instruction, Education.com (2009).

### SUMMARY OF THE EMBODIMENTS

The embodiments of the Stimulating Student Learning Skills Through a Voice-Activated Instructional Aid (“Learning Aid”) include creating a voice-activated system that can effectively infuse student learning strategy instruction with current teaching strategies efficiently and consistently. Over ten years of research was conducted to discover over sixty plus scientific student learning strategies that are proven to raise student achievement. These scientifically proven student learning strategies were used to develop into over 100 student tools that could be integrated within common teaching strategies to increase student comprehension and retention of content. Then, step by step student directives, conducive to voice technology, were developed for each tool, to allow for immediate integration within the classroom. The LC process does not teach content directly but allows the teacher to become a real facilitator of learning by providing both the content and access to tools for the students to approach the learning more successfully. The learning strategies that are activated teach the students how to learn the content and create deep, long-lasting connections for long-term retrieval. Eventually, the habitual use of these learning strategies can help students achieve life-long learning skills. The teacher will align and interject voice-activated student strategies with current, common strategies. This is an innovative process because there are presently no voice technology systems available for the purpose of integrating and aligning scientifically researched student learning strategies with teaching strategies to raise retention, comprehension, and student achievement in classrooms across our nation. This process would be a surprising and significant development because teachers currently do not readily have the time to consistently teach and methodically activate student learning skills during instruction. Unfortunately, due to teacher time constraints in planning and providing instruction in today's classroom, teachers are left doing an abundance of talking, instead of teaching, to cover the textbook and meet current curriculum demands. In summary, this voice-activated instructional support system can change and promote student learning behaviors that can skillfully engage students in a deep, long-lasting learning experience. In addition, for new teachers, the voice-activated process can play a major role in enhancing teaching skills by consistently infusing scientifically proven student learning strategies within the instructional process effectively and efficiently.

The object of this process is to use voice technology directives, as instructional support, to skillfully align and infuse scientifically researched student learning strategies, with common teaching strategies being used in today's classroom. As previously mentioned, the need to provide effective instructional support, that allows all students to successfully comprehend and learn content during the instructional process, runs rampant across the nation. Using voice technology instructional support interventions can instantly provide students with learning strategies that align with the teacher's teaching strategies to increase comprehension, retention and consolidate knowledge for deep, long-term connections for any lesson. These tools consist of an average of three to five ready-made student learning strategy directives that will enhance and validate the understanding of the content throughout any lesson. This voice activated strategy supports are scientifically proven to raise student achievement from approximately 23 to 90 percent. The percentage of student achievement increase from using the voice technology instructional directives depends upon the student learning strategy selected for infusion within the lesson by the teacher during the instructional planning process. For instance, within a reading assignment, a voice activated instructional support tool can activate decoding steps, commonly referred to as learning and processing skills, before and during the reading experience to enhance comprehension skills and enliven the reading occurrence for all students. Even though all students will benefit from this instructional support, it should be noted that currently, up to sixty percent of all high school students do not have the skills to comprehend the reading material in the average classroom” Michael F. Hock & Donald D. Deshler, No Child Leaves Behind Teen Reading Proficiency, 69 The Education Digest 27 (2003). In summary, a voice-activated instructional support process, consists of infusing an average of three to five brief student learning strategy directives, at the beginning of the lesson, during the lecture, during reading, during notetaking, or during the application, reflection and review components. The results will ensure an increase in comprehension, retention and student achievement in classrooms across our nation. Studies have concluded that “the largest struggle for teachers is not learning new approaches to teaching, but implementing them” Joyce & Showers (2002) (as cited in Allison Gulamhussein, Teaching the teachers: Effective professional development in an era of high stakes accountability, Center for Public Education 1 (2013). Learning Connect (“LC”) process tools are intended to save time and effort in instructional planning due to teacher's overwhelming schedule, increasing duties, plus the tremendous pressure for student success. Having so many student learning strategy tools at their fingertips can save teachers a tremendous amount of planning time and effort in the classroom. Teachers do not have time to find and align the many researched-based strategies, copy them from books, then recreate and retype them for classroom use. Therefore, LC can help teachers implement student learning strategies effectively, efficiently and consistently within the classroom. For learning success, good teachers must use good teaching strategies, and good learners must possess and use good learning strategies. Research clearly shows that each learning and processing skill must contribute and function well for overall learning to be easy, fast and successful LearningRX. What Are Cognitive Skills? Brain Training Programs Enhance Your Life (2013-2016) (available at http://www.learningrx.com/cognitive-skills, last visited Jul. 22, 2016). However, the latest educational research shows that 85 to 90 percent of learning difficulties in the classroom are due to poor underlying learning and processing skills. PACE—Processing and Cognitive Enhancement Program. (available at http://processingskills.com/ps/FAQ.html, last visited Jun. 6, 2018) (1998-2013) Unfortunately, for many students, student learning strategies and skills do not come naturally. Educational experts claim that “proficient (good) learners build on and activate their background knowledge before reading, writing, speaking, or listening; poor learners begin without thinking.” J. L. Irvin, J. P. Lunstrum, C. Lynch-Brown & M. F. Shepard, Enhancing Social Studies through Literary Strategies 5 (1996). As a result, educational leaders are also claiming that “classroom tools, imbedded with learning and processing skills, should be adaptable for daily use in all classrooms” Phyllis Blumberg, Developing Learner-Center Teaching: A Practical Guide for Faculty (2008). To approach this dilemma in today's classroom, Dr. Irene Gaskins, educational leader, explains that “in order for the United States to produce young people who are well prepared to succeed in whatever they undertake, every teacher at every grade level in every domain must become a strategies teacher. Strategic instruction needs to be adopted across the curriculum and throughout schools and school districts. It needs to begin when children enter school and continue through 12th grade.” Irene Gaskins, Strategies Instruction, Education.com (Dec. 23, 2009). Research does demonstrate that “students can be taught to use strategies that they have not developed themselves through effective teaching strategies” Stephen D. Luke, Evidence for Education, Volume 1, Issue 1, 2006. The Power of Strategy Education. Center for Parent Information and Resources. (10/2010) (available at http://www.parentcenterhub.org/repository/learning-strategies/, last visited Feb. 5, 2015).

In this respect, before explaining at least one embodiment of the embodiments in detail, it is to be understood that the embodiment is not limited in this application to the details of construction and to the arrangements of the components set forth in the following description or illustrated in the drawings. The embodiment or embodiments are capable of being practiced and carried out in various ways. Also, it is to be understood that the phraseology and terminology employed herein are for description and should not be regarded as limiting. As such, those skilled in the art will appreciate that the conception, upon which this disclosure is based, may readily be used as a basis for the designing of other structures, methods, and systems for carrying out the several purposes of the embodiments. Additional benefits and advantages of the embodiments will become apparent in those skilled in the art to which the present embodiments relate from the subsequent description of the preferred embodiment and the appended claims, taken in conjunction with the accompanying drawings. It is important, therefore, that the claims be regarded as including such equivalent constructions insofar as they do not depart from the spirit and scope of the embodiments.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1 is the first portion of a flow chart of an embodiment of the Teacher Instructional Planning and Implementation Tool Process with the option to select the process by Lesson Component.

FIG. 2 is the second portion of the flow chart of an embodiment of the Teacher Instructional Planning and Implementation Tool Process with the option to select the process by Lesson Component.

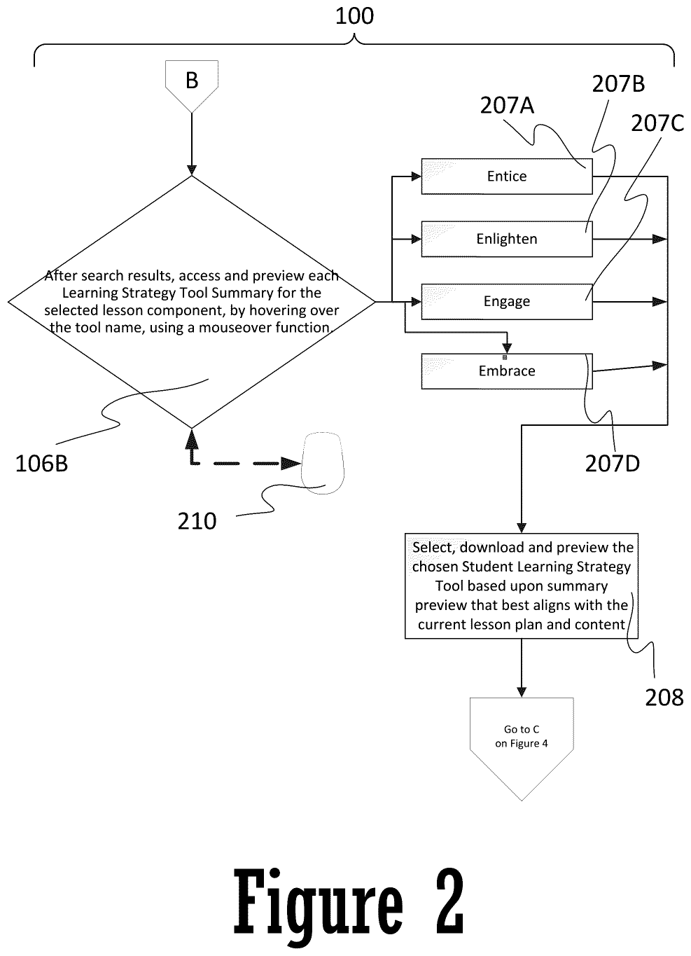

FIG. 3 is the first portion of the flow chart of an embodiment of the Teacher Instructional Planning and Implementation Tool Process with the option to select the process by Tool Component.

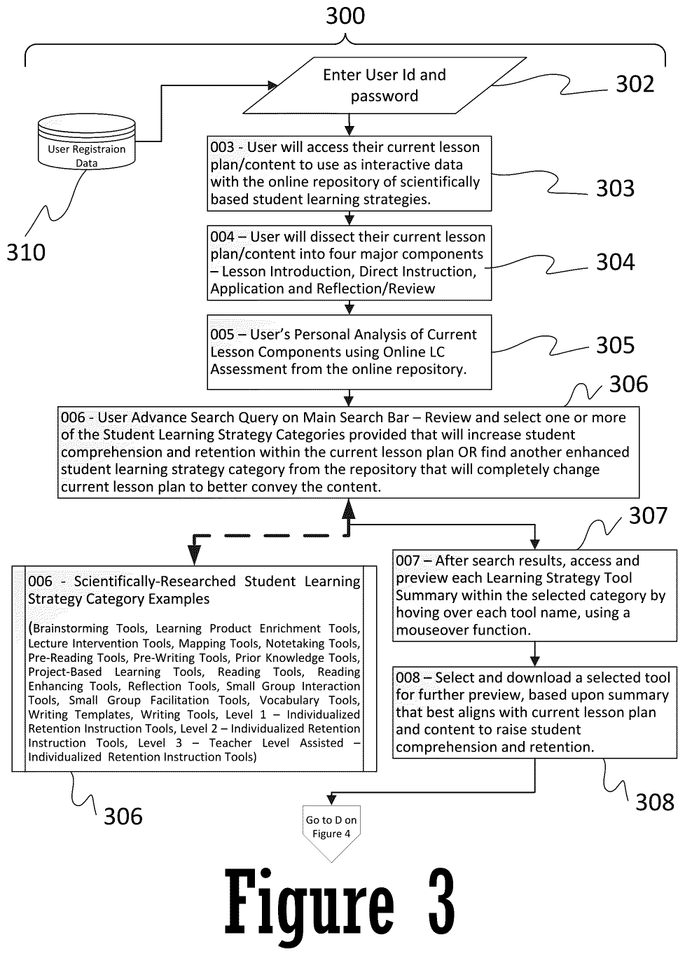

FIG. 4 is the third portion of the flow chart of an embodiment of the Teacher Instructional Planning and Implementation Tool Process with the option to select the process by Lesson Component and Tool Component.

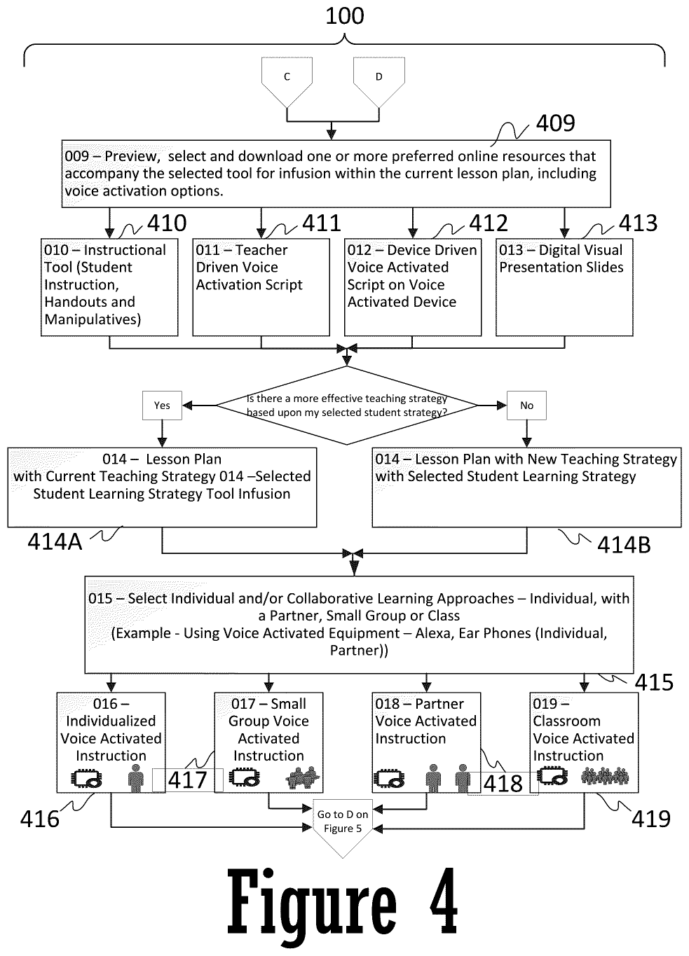

FIG. 5 is the fourth portion of a flow chart of an embodiment of the Teacher Instructional Planning and Implementation Tool Process with the option to select the process by Lesson Component and Tool Component.

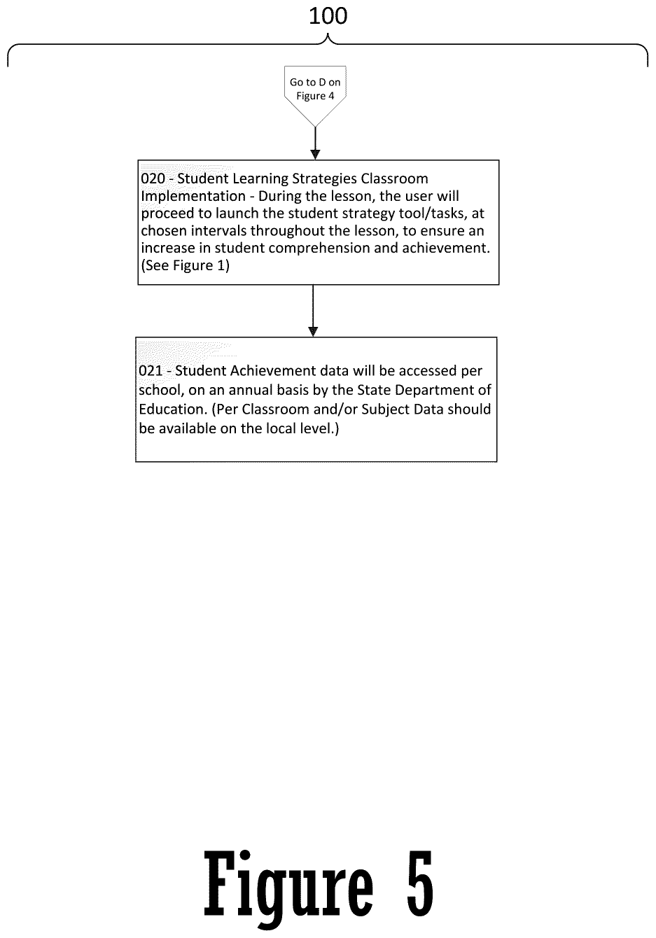

### DETAILED DESCRIPTION OF THE PREFERRED EMBODIMENTS

An embodiment of the Stimulating Student Learning Skills Through a Voice-Activated Instructional Aid (hereinafter “Learning Aid”) 100 permits Teacher Instructional Planning and Implementation per a by lesson component. This embodiment of the Learning Aid 100 comprised of entering a Userid/Password pair 102 which confirms the identity of the user from a Teacher Registration Database 150. Then, the Learning Aid 100 retrieves the state specific class student achievement grade report 101 from a database 151. Now that the state specific class student achievement grade report 101 is known the Learning Aid 100 retrieves the current lesson plan and content from the repository of learning strategies 103 from the database 151.

The term state achievement data means the quantitative and qualitative measurements that collectively evaluate the students' academic performance on the local school level and make available to the state level from external local and state databases. The term specific class student achievement grade reports means formal documents issued by the school that communicate student academic performance or progress per student and collectively per class for a specified time period. The term achievement school reports from local, state and/or national achievement databases means quantitative and qualitative measurements that evaluate student's academic performance collectively at the local, state, or national level. The term curriculum content means the specific topics, concepts and information designed in a logical order to achieve particular learning objectives.

The Learning Aid 100 Dissects the current lesson plan into four major components 104: 1) Lesson Introduction (ENTICE), 2) Direct Instruction (ENLIGHTEN), 3) Application (ENGAGE) and 4) Reflection/Review (EMBRACE). Then the Learning Aid 100 retrieves the Retrieve user's personal analysis of the current lesson components using online LC Assessment from the online cloud repository 152. Then the Learning Aid 100 requests the user to select one of the preferred Student Learning Strategy Components 106A—ENTICE, ENLIGHTEN, ENGAGE or EMBRACE—to increase student comprehension and retention within the current lesson plan.

The term LC Assessment means a self-assessment of a lesson plan for long-term student retention strategies. The term EMBRACE means the reflection and review for student long term retrieval. Next, the Learning Aid 100 asks the user to Select Time Frame or Intensity preferred for tool implementation, for example 10 Minute Thinkers, 20 Minute Thinkers, 30 Minute Thinkers, or Project Level Thinkers 106B. The term 10 Minute Thinkers means prompts or directives provided during the teaching process that can be completed within a ten-minute period and allows learners to reflect, restructure, and consolidate content for long-term retrieval. The term 20 Minute Thinkers means prompts or directives provided during the teaching process that can be completed within a twenty-minute period and allow learners to reflect, restructure, and consolidate content for long-term retrieval. The term 30 Minute Thinkers means prompts or directives provided during the teaching process that can be completed within a thirty-minute period and allow learners to reflect, restructure, and consolidate content for long-term retrieval. The term Project Level Thinkers means prompts or directives provided during the teaching process that can be completed as a problem-solving or investigative process to allow learners to reflect, restructure, and consolidate content for long-term retrieval.

One intensity instructional mode option that denotes all strategy tools within the same component, with the same/similar intensity or time framework, such as 10 Minute Thinkers, 20 Minute Thinkers, 30 Minute Thinkers. Another intensity instructional mode option is a noted team project delivery mode, denoting learning tools for planning, organizing, executing and monitoring a learning project, including student leadership development and communication teamwork ploys [106B]. Yet another intensity instructional mode option is a noted journaling reflective delivery mode option, signified by the journaling symbol, and denoting all tools available with non-voice-activated or optional voice journaling prompts.

The term LC Lesson Component Assessment tool means a self-assessment instrument with criteria for a teacher to use to appraise each section of his/her current lesson for the inclusion of student learning strategies that ensure the retention and long-term retrieval of content. The term student achievement enhancement means improvement of student knowledge and skills. The term 10 Minute Thinkers activity means that a student responds to prompts to discover their own prior knowledge, enrich vocabulary and reading, to reflect on the lesson or validate understanding (IND 1). IN another option (IND 2) the student can work with a partner for 20-30 mins. In yet another option IND 3 or Teacher Level Assistance, the teacher facilitates and provides materials and the student can work with a PARTNER. In all of these options, the student uses voice activated equipment or other voice prompt activated equipment provides activity directives to re-organize and consolidate knowledge, such as constructing a concept map or another graphic from their notes; constructing a rubric (for the components or steps) or construct a learning product. The term voice activated equipment means devices or other voice prompt activated equipment that can wirelessly connect to an intranet, the internet, or cloud to perform searches or execute other commands via the voice of the student, teacher or other user. Examples of voice activated equipment are Alexa devices, Google Home devices, wirelessly connected speakers, or other similar internet connected appliances. The voice activated equipment provides activity directives to re-organize and consolidate knowledge, such as constructing a concept map or another graphic from their notes; constructing a rubric (for the components or steps) or constructing a learning product. In addition, the voice activated equipment provides directives for students to do mapping, conduct extensive comparisons, develop reflection questions, create written reflections, including different perspectives, opinions and justifications. The term Learning Products means a storyboard, cartoon, web framework, musical mnemonics or a visual presentation on the lesson topic.

The term Learning Connect means an online virtual assistant for secondary teachers to access and parallel successful student learning tools within their current lessons, fast and efficiently, with minimal instructional planning, while supporting teachers in aligning and providing student learning strategies within their current or upcoming lesson plans to enhancing comprehension, retention and long-term retrieval of content. Further, Learning Connect means a repository of provides both new and “tried and true” engaging processes that good teachers and good students use for learning success. The term Common Strategies means the common, wide-spread instructional strategies used by teachers for students to retain content, such as lecture, reading assignments and study sheets. The term State Specific Class Student Achievement Grade Report, commonly referred to as School Report Cards, means a snapshot of the school's performance by measuring multiple indicators, including academic achievement, academic growth and graduation success. These indicators receive a point value that transforms into an overall letter grade for the school. The purpose of this critical information is to stimulate conversations about school successes and areas needing improvement. The term Teaching Strategies means instructional methods teachers use to assist students in attaining learning objectives within the planned lesson. The term Learning Strategies means the learning methods and processes that students use to learn new information and content. The term Student Strategies means learning strategies that students use to retrieve, engage and process new information and content. The term Lesson Introduction—ENTICE means the initial teaching step to acquire student learners' focus and attention, while activating their prior knowledge of the upcoming content to be presented. The term Direct Instruction—ENLIGHTEN means a structured, sequenced approach led by the teacher to convey learning content and transform surface learning into a deep successful learning event. The term Application—ENGAGE means involved, interactive and engaging encounters to compare, connect, re-organize and retain the new knowledge received. The term Reflection/Review—EMBRACE means the final learning step of reflecting, connecting and retaining the knowledge gained for long-term retrieval. The term Student Learning Strategy Components means steps or stages of the learning process, commonly used in effective lesson plans. The term Online LC Assessment means an assessment document for teachers to assess their current practice of aligning and providing student learning strategies that effectively enhance comprehension, retention and long-term retrieval of content. The term student assessment data means the information gathered which is used to evaluate and measure a student's progress in achieving and retaining the skills, knowledge and learning outcomes of a specified subject or curriculum area.

After searching and accessing a learning strategy tool summary, the Learning Aid 100 allows the user to preview each Learning Strategy Tool Summary by hovering over the tool name, using a mouse-over function with a computer pointing device 210 chat is a computer mouse, a stylus, or other hardware tool that allows a user to point to portion of a screen. The Learning Aid 100 then downloads the student learning strategy tool 208 based on the summary preview that best aligns with the current lesson plan and content.

Then the Learning Aid 100 previews, selects and downloads one or more preferred online resources that accompany the selected tool for infusion within the current lesson plan, including voice activation options 409. The various tools include student instruction, handouts and manipulatives 410 followed by lesson plan with current teaching strategy 414A; teacher driven voice activation script on voice activated device 411 followed by selected student learning strategy tool infusion 414B; device driven voice activated script 412 followed by lesson plan with new teaching strategy 414C; or digital visual presentation slides 413 followed by selected student learning strategies 414D. The term teacher-driven script means a script administered by the teacher with learning prompts and responses to guide student learners through behaviors to reflect, restructure, and consolidate content for long-term retrieval. The term voice activated prompts and directives means learning prompts or directives that trigger a voice activated device to provide an appropriate response. The term student-driven voice activated prompts means directives provided to the student to activate responses and behaviors for reflecting, restructuring, and consolidating content for long-term retrieval.

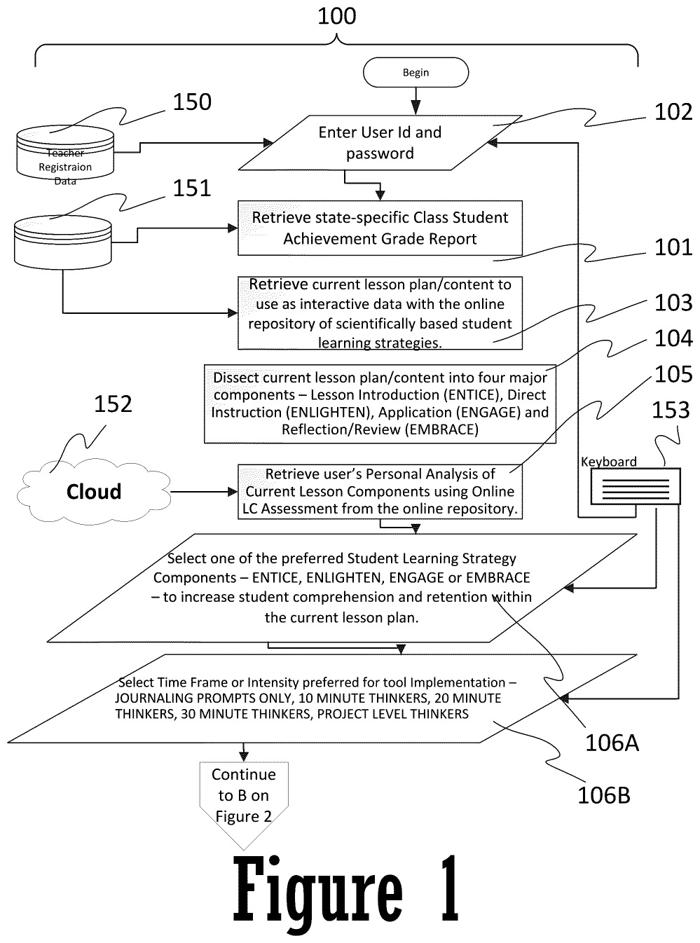

Then the Learning Aid 100 selects Individual and/or Collaborative Learning Approaches including Individual, with a Partner, a Small Group or the entire class 415. As an example, the Collaborative Learning Approaches include using voice activated equipment such as a cloud-based voice service available (Alexa or Google Home), earphones and a partner. During the lesson, then the Learning Aid 100 will instruct the user to proceed to launch the student strategy tool/tasks, at chosen intervals throughout the lesson, to ensure an increase in student comprehension and achievement. (See FIG. 1). Then the Learning Aid 100 permits the Student Achievement data to be accessed per school, on an annual basis by a state educational organization. Classroom and Subject Data will be made available on the local level.

The term achievement data means the quantitative and qualitative measurements that evaluate a student's academic performance or learning progress. The term student learning achievement strategies means strategies that can help students engage in tasks and behaviors that result in mastery skills, retention, and long-term retrieval. The term supportive and aligning student learning strategies means student learning strategies that can be integrated into common, current teaching strategies to ensure an increase in retention and long-term retrieval. The term strategy interventions means a brief intervention during the teaching process to allow students to reflect, restructure, consolidate and retain content for long-term retrieval. The term preferred instructional strategy means the technique or process favored by the teachers to help students learn academic content.

Another embodiment of the Learning Aid 300 permits Teacher Instructional Planning and Implementation per tool category. This embodiment of the Learning Aid 300 is comprised of entering a Userid/Password pair 302 which confirms the identity of the user from a Teacher Registration Database 310. Then, the Learning Aid 300 will access the user's current lesson plan/content to use as interactive data with the online repository of scientifically based student learning strategies 103. The Learning Aid 300 then dissects the current lesson plan into four major components 104: 1) Lesson Introduction (ENTICE), 2) Direct Instruction (ENLIGHTEN), 3) Application (ENGAGE) and 4) Reflection/Review (EMBRACE). Then the Learning Aid 300 retrieves the Retrieve user's personal analysis of the current lesson components using online LC Assessment from the online cloud repository 305. Then the Learning Aid 300 allows the user to review and select one or more of the Student Learning Strategy Categories provided that will increase student comprehension and retention within the current lesson plan or find another enhanced student learning strategy category from the repository that will completely change current lesson plan to better convey the content using an advanced search button 306. The scientifically-researched student learning strategy category comprises brainstorming tools, learning product enrichment tools, lecture intervention tools, mapping tools, notetaking tools, pre-reading tools, pre-writing tools, prior knowledge tools, project-based learning tools, reading tools, reading enhancing tools, reflection tools,—small group interaction tools, small group facilitation tools, vocabulary tools, writing templates, writing tools, individualized retention instruction tools, individualized and/or partner, retention instruction tools, and teacher level assisted individualized and/or partner, retention instruction tools. The term Individualized instruction means the personal educational approach that tailors the learning experience to meet the needs of each individual learner.

Then the Learning Aid 300 accesses and previews each Learning Strategy Tool Summary within the selected category by hovering over each tool name, using a mouse-over function with a computer pointing device 210 chat is a computer mouse, a stylus, or other hardware tool that allows a user to point to portion of a screen 307. Then the Learning Aid 300 selects and downloads the selected tool for further preview, based upon summary that best aligns with current lesson plan and content to raise student comprehension and retention.

Then the Learning Aid 100 previews, selects and downloads one or more preferred online resources that accompany the selected tool for infusion within the current lesson plan, including voice activation options 409. The various tools include student instruction, handouts and manipulatives 410 followed by lesson plan with current teaching strategy 414A; teacher driven voice activation script on voice activated device 411 followed by selected student learning strategy tool infusion 414B; voice activated device driven voice activated script 412 followed by lesson plan with new teaching strategy 414C; or digital visual presentation slides 413 followed by selected student learning strategies 414D.

Then the Learning Aid 100 selects Individual and/or Collaborative Learning Approaches including Individual, with a Partner, a Small Group or the entire class 415. As an example, the Collaborative Learning Approaches include Using Voice Activated Equipment such as a cloud-based voice service available (Alexa or Google Home), earphones and a Partner. During the lesson, then the Learning Aid 100 will instruct the user to proceed to launch the student strategy tool/tasks, at chosen intervals throughout the lesson, to ensure an increase in student comprehension and achievement. (See FIG. 1). Then the Learning Aid 100 permits the Student Achievement data will be accessed per school, on an annual basis by a state educational organization. Classroom and Subject Data will be made available on the local level. The term partner instruction means the educational approach that involves students working together in pairs to practice skills or achieve a targeted concept with clear expectations during an established time period. The term short-term small group/team instruction means the educational approach where a small group works collaboratively on a targeted concept with clear expectations within a short or brief time period.

The term individualized to partner instruction means an educational approach that transitions from individualized to partner instruction with clear expectations to achieve the learning objectives of the lesson. The term individualized to small group/team instruction partner to small group/team instruction means the educational approach that transitions from individualized to small group instruction with clear expectations to achieve the learning objectives of the lesson. The term long-term small group or project instruction means the educational approach in which students learn about a subject by working in groups to solve an open-ended problem. The term small group role draw cards means a card that can be drawn by a small group participant to determine their small group role and sequence of participation in completing the overall expectations and instructional task of the group. The term draw card container means a paper pouch-like device that can be constructed from the printed diagram and directions provided within each applicable online Learning Connect learning tool for the purpose of enabling the drawing card distribution process within a group. The term guidance sheets mean sheets provided to a small group participant to provide direction and guidance for achieving optimal results when performing their assigned or drawn participatory small group role. The term facilitator script means written text provided to the facilitator to guide and manage the collaborative expectations and outcomes of a group. The object of the process is to provide voice technology instructional support interventions that can instantly provide learners with scientifically proven student learning strategies to align with the teacher's teaching strategies. This process would increase the effectiveness and efficiency of teachers in activating student learning skills, while implementing their current teaching strategies and curriculum. As directed by an instructor, students will be asked to respond, individually, with a partner, in a small group or as a class, to the voice technology, activated by the instructor, during the lesson. The electronic device will provide three to five step-by-step directives requesting student behavior tasks that are scientifically proven to increase student learning skills, using the content being presented. For example, the teacher can infuse the directives when introducing a lesson, while lecturing, assigning a reading lesson, demonstrating a lesson or reviewing the content. It may change the lesson plan a little but does not change the content of the lesson. By helping students develop good learning approaches and habits, the results will increase student achievement and unveil a pathway for the students to engage in life-long learning. For instance, the voice technology strategy intervention is activated at the beginning of the lesson to help students access prior knowledge and prepare to learn the new content. Since learning proceeds primarily from prior knowledge, and only secondarily from presented material. It is prior knowledge that creates the connection of new content and constructs the meaning. (Gaskins, 2009). However, educational experts have concluded that for many students, prior knowledge is not always readily activated when trying to learn new information, help is needed to make the right connections. (McPherson, 2012). (Roschelle, 2014). Many innovative voice-activated tools were created to help students prepare to learn by accessing their prior knowledge on the upcoming topic, at the beginning of the lesson. Then, in other instances, throughout the lesson, the teacher can launch voice-activated tools to trigger critical thinking and reflection techniques that increase comprehension and consolidate knowledge for a deep, long-term connection within any lesson. It should also be noted that the voice-activated process enhances engagement and enlivens any lesson or classroom for all students. It does not take the place of the teacher but allows the teacher to become a real facilitator of learning by providing both the guidance, content and access to tools for the students to approach the learning more successfully. For new teachers, this voice-activated instructional support process can play a major role in enhancing their teaching skills by consistently aligning and infusing scientifically proven student learning strategies within their instructional process effectively and efficiently. As a result, new teachers can rapidly develop the same attributes and skills of a master teacher within a short time period.

The student learning strategies can be integrated as part of the lesson introduction, the lecture, during reading assignment, the lesson application or lesson review. Teacher previews student learning strategies online, selecting the student learning strategy that best aligns with their current planned teaching strategy and curriculum. The selected student learning strategy tool and script is previewed online or downloaded by the teacher. Using the script, the teacher or student leader will proceed to launch the student strategy tasks using provided activation questions and statements at chosen intervals throughout the lesson. The electronic device will provide three to five step-by-step instructions requesting student behavior tasks that are scientifically proven to increase retention and comprehension of the content presented. The student learning strategy does not take the place of the teacher, buy allows the teacher to become of a Facilitator of learning.

As a result of completing the Learning Aid 100 or Learning Aid 300, scientifically proven-student learning strategies are infused and aligned with current teaching strategies. This voice-activated technology provides step by step student directives, developed for immediate use within the classroom with minimum instructional planning, to increase student retention, comprehension and long-term retrieval of content provided. The term online deaccession means officially removing or disposing of an item from a collection or list using an online system and user's selected preferences.

What is claimed is:

1. A learning aid comprising the steps
a. prompt the user to enter a user ID/password pair that confirms the identity of the user from a teacher registration database [150];
b. prompt user for a URL to retrieve achievement data from school specific student achievement from an external local and state database, specific class student achievement grade reports [101], or achievement school reports from local, state and/or national achievement databases [151];
c. prompt user for a URL to retrieve curriculum content based on the achievement data;
d. prompt user for a URL to retrieve a selected current lesson plan from the curriculum content to add active learning student strategies or strategy interventions for the purpose of raising student achievement;
e. prompt user to select which student learning strategy category to use from the group consisting of lesson introduction, direct instruction, application, and reflection and review;
f. prompt user for a URL to select an online LC Lesson Component Assessment tool to appraise each component within their selected lesson plan for potential integration of more engaging student learning strategies or strategy interventions to enhance student achievement selected from the group consisting of lesson introduction-entice component, direct instruction-enlighten component, application-engage component, and reflection and review-embrace component [152];
g. for online deaccession of the computer-generated component list, prompt the user to choose their self-selected component based upon the previous assessment to acquire a list of aligning active student learning strategies or strategy interventions that could enhance student achievement selected from the group consisting of entice component, enlighten component, engage component or embrace component;
h. for further online deaccession or narrowing of list of prospective student learning achievement strategies or strategy interventions aligning with their lesson plan, prompt user to choose their preferred delivery intensity, amplified by time framework and other noted delivery options, including reflective journaling and team project learning;
i. preview to the user the narrowing computer-generated list of supportive and aligning student learning strategies or strategy interventions for integration into their chosen lesson plan by allowing the user to hover a mouse over each remaining strategy or intervention tool to receive a more in-depth description;
j. from the more in-depth description, prompt user to select a preferred instructional strategy or strategy intervention (from the remaining computer list and descriptions) to integrate within their lesson plan as a component or replacement of their current lesson plan for the purpose of student achievement enhancement;
k. prompt user to preview and select from the aligning computer-generated list of specific resources available for the learning strategy or intervention identified selected from the group consisting of instructional tool, with ready-made instructions, including handouts and manipulatives; a teacher-driven script, including voice activated prompts and directives, student-driven voice activated prompts and digital slide presentation;
l. prompt user to select from the computer-generated list of recommended teaching approaches or modes of instruction for the identified learning strategy or learning strategy intervention tool selected from the group consisting of individualized instruction, partner instruction, short-term small group/team instruction, individualized to partner instruction, individualized to small group/team instruction partner to small group/team instruction, and long-term small group or project instruction;
m. prompt user to preview and select from a computer-generated list of additional instant handouts or manipulatives for the selected mode of teaching or teaching approach, including the following example of resources for a short-term small group mode of instruction selected from the group consisting of small group role draw cards, draw card container, small group role guidance sheets, and facilitator script;
n. prompt user to select a new lesson plan with new student learning strategies or learning strategy intervention, including the download of preferred tools and resources generated by computer, based upon user selection;
o. prompt user to view the student assessment data following successful implementation of student learning strategy or strategy intervention within the identified lesson plan using local student database.
